(19) United States
(12) Patent Application Publication
(10) Pub. No.: US 2023/0356176 A1
(43) Pub. Date: Nov. 9, 2023

(54) Device and Method for Controllably Carrying Out a Chemical Reaction

(71) Applicants: Linde GmbH, Pullach (DE); BASF SE, Ludwigshafen (DE)

(72) Inventors: Christian Lang, München (DE); Martin Hofstatter, München (DE); Mathieu Zellhuber, Martinsried (DE); Anton Wellenhofer, Hohenschaftlarn (DE); Robert Stegemann, München (DE); Peter Reiser, Münsing (DE); Niklas Fleischmann, München (DE); Christian Ziegler, München (DE); Heinz Posselt, Bad Aibling (DE); Clara Delhomme-Neudecker, München (DE); Andrey Shustov, Ludwigshafen Am Rhein (DE); Eric Jenne, Hassloch (DE); Heinz-Jurgen Kuhn, Westhofen (DE); Kiara Aenne Kochendorfer, Mannheim (DE); Heinrich Laib, Limburgerhof (DE); Reiner Jacob, Hochspeyer (DE)

(21) Appl. No.: 18/246,846

(22) PCT Filed: Sep. 27, 2021
(86) PCT No.: PCT/EP2021/076543

§ 371 Date: Mar. 27, 2023

(30) Foreign Application Priority Data
Sep. 28, 2020 (EP) 20198794.8

(51) Int. Cl. B01J 19/24; B01J 8/06

(52) U.S. Cl. CPC B01J 19/243; B01J 8/067; B01J 2219/00135; B01J 2208/00415

(57) ABSTRACT

A method for regulatedly carrying out a chemical reaction in a reactor having reaction tubes which have a number of electrically heatable tube sections, wherein power connections are provided, which are each connected to at least one of the tube sections, wherein at least one connecting element is provided and each of the tube sections is connected to the connecting element. The method comprises conducting a process fluid through the one or more reaction tubes, providing several variable voltages at the several power connections, wherein the several voltages are provided as phases of a multiphase AC voltage so that the at least one connecting element forms a star point, setting the one or more voltages; detecting one or more measured values corresponding to one or more measured variables; changing the several set voltages so that the detected measured values correspond to predetermined values or value ranges of the measured variables.

### CROSS-REFERENCE TO RELATED APPLICATIONS

This application is the national phase of, and claims priority to, International Application No. PCT/EP2021/076543, filed Sep. 27, 2021, which claims priority to European Application No. 20198794.8, filed Sep. 28, 2020.

### FIELD OF THE INVENTION

The invention relates to an apparatus and a method for regulatably carrying out a chemical reaction in a reactor with at least one heatable reaction tube.

### BACKGROUND

In a series of processes in the chemical industry, reactors are used in which one or more reactants are conducted through heated reaction tubes and are catalytically or non-catalytically 20 converted there. The heating serves in particular to overcome the required activation energy for the chemical reaction taking place. The reaction can proceed endothermically overall, or exothermically after overcoming the activation energy. The invention relates in particular to strongly endothermic reactions.

Examples of such processes are steam cracking, different reforming processes—in particular, steam reforming, dry reforming (carbon dioxide reforming), mixed reforming processes, processes for dehydrogenating alkanes, and the like. In steam cracking, the reaction tubes are guided through the reactor in the form of tube coils, which have at least one U-bend in the reactor, whereas, in steam reforming, tubes which typically extend through the reactor 30 without U-bend are used.

The invention is suitable for all such processes and embodiments of reaction tubes. Merely illustratively, reference is made to the articles, “Ethylene,” “Gas Production,” and “Propenes,” in Ullmann's Encyclopedia of Industrial Chemistry—for example, the publications of Apr. 15, 2009, DOI: 10.1002/14356007.a10_045.pub2, of Dec. 15, 2006, DOI: 10.1002/14356007.a12_169.pub2, and of Jun. 15, 2000, DOI: 10.1002/14356007.a22_211.

The reaction tubes of corresponding reactors are conventionally heated by using burners. The reaction tubes are guided through a combustion chamber in which the burners are also arranged.

However, as described, for example, in DE 10 2015 004 121 A1 (likewise, EP 3 075 704 A1), the demand for synthesis gas and hydrogen, which are produced without or with reduced local carbon dioxide emissions, is currently increasing. However, processes in which fired reactors are used cannot meet this demand due to the combustion of, typically, fossil energy carriers. Other processes are rejected due to high costs, for example. The same also applies to the provision of olefins and/or other hydrocarbons by steam-cracking or dehydrogenating alkanes. In such cases, too, there is a desire for processes which emit lower amounts of carbon dioxide, at least on-site.

Against this background, the cited DE 10 2015 004 121 A1 proposes electrical heating of a reactor for steam reforming, in addition to firing. Here, one or more voltage sources are used, which provide(s) a three-phase alternating voltage on three outer conductors. Each outer conductor is connected to a reaction tube. A star connection is formed, in which a star point is realized by a collector into which the tube lines open and to which the reaction tubes are conductively connected. In this way, the collector ideally remains potential-free. In relation to the vertical, the collector is arranged below and outside the combustion chamber and preferably extends transversely to the reactor tubes or along the horizontal. WO 2015/197181 A1 likewise discloses a reactor whose reaction tubes are arranged in a star-point connection. WO 2020/035575 A1 relates to a device for electrically heating a fluid by means of at least one direct current. DE 10 2011 077 970 A1 relates to an apparatus with electrically-conductive heating elements, arranged in a treatment chamber, for the temperature treatment of corrosive gases.

During operation of such reactors with electrically-heated reaction tubes, a change in the electrical properties (resistances) of the reaction tubes can occur on the one hand, and changes in the amount and/or the composition of the reaction products can be desired on the other. An object is therefore to be able to adapt the operating conditions of the reactor, or the reaction parameters of a chemical reaction carried out therewith, to such changes during operation. Furthermore, there is also an object of being able to adapt the electrotechnical operating conditions to such changes—in particular, when using multiphase AC voltage on the outer conductors.

### SUMMARY

According to an embodiment of the invention, a method for regulatably carrying out a chemical reaction in a process fluid in a reactor, includes first providing a reactor. The reactor has at least one reaction tube, each reaction tube having one or more electrically heatable tube sections. Several power connections are provided, and each power connection is connected in a current input area to a respective tube section. At least one connecting element, provided in a current output area, electrically-conductively connects each tube section. The method continues by conducting the process fluid through the at least one reaction tube. Several variable voltages are provided at the several power connections, and are provided as phases of a multiphase AC voltage so that the at least one connecting element forms a star point. The several voltages are set, and one or more measured values corresponding to one or more measured variables are detected. The method proceeds by changing the several set voltages so that the detected measures values correspond to predetermined values or value ranges for the measured variables. The chemical reaction is selected from the list consisting of: steam cracking, steam reforming, dry reforming, propane dehydrogenation, and a reaction with hydrocarbons, which is carried out at least partially at more than 500° C.

### BRIEF DESCRIPTION OF THE DRAWINGS

FIG. 1 shows an apparatus according to a preferred embodiment of the invention.

FIG. 2 shows an apparatus according to a further preferred embodiment of the invention.

FIG. 3 shows a power source which can be used according to a preferred embodiment in an apparatus according to the invention.

FIG. 4 shows a further power source which can be used according to a preferred embodiment in an apparatus according to the invention.

FIG. 5 shows a flowchart according to one embodiment of the method according to the invention.

### DETAILED DESCRIPTION OF THE INVENTION

Methods and an apparatus for regulatably carrying out a chemical reaction are described herein.

The chemical reaction proceeds in several reaction tubes through which the process fluid, i.e., the fluid with the reactants (typically a gas or gas mixture), is conducted. Tube 25 sections of the reaction tubes are electrically heatable, wherein the tube sections are connected with power connections to one (or several) controllable power source or voltage source, at which electrical currents or voltages for electrical heating are provided. The voltages are provided as phases of a multiphase AC voltage. According to the invention, the voltages applied to the power connections can be changed—in particular, individually. This makes it possible, on the one hand, to keep constant the heating powers at the tube sections in the event of varying electrical properties. A change in the electrical properties can be caused, for example, by inductive effects due to electromagnetic fields of current-conducting components, variable temperatures within the reactor, a coke layer formed during operation, variable heat demand as a result of changing endothermy/exothermy of the reactions, or also manufacturing tolerances or material variations. On the other hand, the heating powers can be varied in a targeted manner in order to enable an adaptation of the composition of the reaction products, which is in particular dependent upon the process temperature. Furthermore, the heating power may also be varied in a targeted manner in order to be able to carry out an adjustment of the quantity of the reaction products, in the case of a controlled composition.

The chemical reaction may be one of the following: steam cracking, steam reforming, dry reforming (carbon dioxide reforming), propane dehydrogenation, generally reactions with hydrocarbons that are carried out at least partially at over 500° C. In more general terms, the chemical reaction may be a chemical reaction that proceeds at least partially at a temperature in the range of 200° C. to 1,700° C., and in particular of 300° C. to 1,400° C. or of 400° C. to 1,100° C. The chemical reaction is preferably a chemical reaction that proceeds at least partially at a temperature of at least 500° C., more preferably of at least 700° C., and in particular at least partially in a temperature range of 500° C. or 700° C. to 1,100° C. The provided electrical voltages/currents are accordingly suitable for providing corresponding heating powers. The reactor and the power source are likewise configured to carry out chemical reactions at these temperatures and to provide corresponding heating powers.

More specifically, the reactor is provided with several reaction tubes which have a number of electrically heatable tube sections, wherein several power connections are provided, which are each connected in a current input area to at least one of the tube sections, wherein at least one connecting element is provided in a current output area, and each of the tube sections is connected to a connecting element. Specifically, the method according to the invention for regulatably carrying out a chemical reaction in a reactor comprises conducting a process fluid through the several reaction tubes, providing several variable voltages at the several power connections, wherein the several voltages are provided as phases of a multiphase AC voltage so that the at least one connecting element forms a star point (connecting-element star point), setting the several voltages, detecting one or more measured variables, and changing the several set voltages, so that measured values of the detected measured variables correspond to predetermined values or value ranges of the measured variables.

The several provided voltages in this case are in one or more predetermined voltage ranges, which correspond to heating powers that are delivered to the electrically heated tube sections and which enable the chemical reaction in the tube sections, i.e., which heat the latter to a suitable temperature.

Measuring devices, with which these measured variables are detected, and their arrangement are described in connection with embodiments of the apparatus according to the invention. The change or control of the voltages at the power connections takes place as a function of measured values of the measured variables detected by the measuring devices. This change takes place such that the measured values correspond to specified values or value ranges of the measured variables. The wording, “correspond,” is to be understood here to mean that the measured values are equal to or as close as possible to the specified values or are in the specified value ranges. In particular, a control loop is thus implemented, wherein the voltages can be regarded as manipulated variables, and the measured variables can be regarded as control variables.

The voltages or the corresponding electrical currents are provided as alternating voltages or alternating currents. The current input takes place in the form of multiphase alternating current into the directly heated reaction tubes or the tube sections thereof via M separately connected phases which are assigned to the power connections (each power connection is thus connected to one of the phases). The current-conducting reaction tubes or tube sections which are connected via the power connections to the M phases are, advantageously, likewise electrically-conductively connected at a star point by the connecting element (in the current output area). The phase number M is in particular 3, corresponding to the phase number of conventional three-phase alternating current sources or three-phase alternating current supply grids. In principle, however, the invention is not limited to the use of three phases, but can also be used with a different, and in particular larger, phase number—for example, a phase number of 2, 4, 5, 6, 7, or 8. A phase offset is in particular 360°/M, i.e., in the case of a three-phase alternating current, 120°. The advantage of multiphase alternating current is that the currents of the phases in the star point cancel one another out when the load is substantially symmetrical, so that no or only little electrical return current to the voltage supply or power source occurs. The voltages are thus provided as phases of a multiphase AC voltage. The power source used for this purpose is, accordingly, preferably a multiphase alternating current source.

Preferably, the measured variables comprise one or more of at least one temperature, at least one current intensity, and/or at least one substance composition. As a result, the control of the chemical reaction can take place as a function of at least one process temperature, at least one heating power (which is dependent upon the current intensity), or at least one composition of the reaction product or the original reactants (i.e., a substance composition of the process fluid at the tube inlet or at the tube outlet). Corresponding desired values/ranges can thus be achieved.

The several voltages can be changed in the same way, i.e., they are changed together, and not independently of one another. Preferably, the several voltages are changed independently of one another, i.e., each of the voltages can be individually set, independently of the other voltages.

Preferably, the one or more measured variables comprise one or both of: a tube outlet temperature, measured at a tube outlet of the several reaction tubes, of the process fluid, and/or a substance composition, measured at a tube outlet of the several reaction tubes, of the process fluid. More preferably, the several voltages are changed such that the measured tube outlet temperature and/or the measured substance composition is equal to or as close as possible to a predetermined tube outlet temperature and/or a predetermined substance composition, or is within a predetermined value range. The composition of the reaction product is, in particular, dependent upon the process temperature (of which the tube outlet temperature is a measure) with which the chemical reaction proceeds and can therefore be directly influenced via said process temperature in terms of control technology. By changing the voltages and thus the heating power, particular desired compositions of the reaction product can thus be achieved. If several reaction tubes are present, the measured variables can accordingly comprise several tube outlet temperatures and/or several substance compositions at tube outlets. It is also possible to additionally or alternatively use, as measured variables, corresponding temperatures or substance compositions measured at one or more tube inlets, i.e., the measured variables can comprise one or more tube inlet temperatures and/or one or more tube inlet substance compositions. Furthermore, it is possible to additionally or alternatively use, as measured variables, corresponding temperatures measured at one or more intermediate positions on one or more reaction tubes, i.e., the measured variables can comprise one or more intermediate position temperatures on one or more reaction tubes.

Preferably, the one or more measured variables comprise one or both of: two or more tube section temperatures measured at tube sections connected to various power connections, or two or more power connection current intensities measured at various power connections. Further preferably, the several voltages at the various power connections are controlled such that the measured tube section temperatures correspond to predetermined tube section temperatures, and/or power outputs, calculated from the current intensities, at the tube sections connected to the various power connections correspond to predetermined power outputs. This makes it possible to supply heating powers of different strengths to tube sections connected to different power connections, so that, in particular, different temperatures can also be set at these different tube sections. Here, an increased return current may occur via a neutral conductor.

If different tube sections of a single reaction tube (tube coil) are connected to different power connections, a desired heating power profile or temperature profile along the reaction tube can be generated. Preferably, the method thus comprises setting different voltages at different tube sections of a reaction tube, which are connected to different power connections, in order to supply these tube sections with different heating powers.

Preferably, the one or more measured variables comprise one or both of: a neutral conductor current intensity measured at a neutral conductor, or two or more power connection current intensities measured at various power connections. Further preferably, the voltages are changed such that the neutral conductor current intensity is minimized, and/or a sum, calculated taking into account the relative phases, of the power connection current intensities is minimized. In other words, the neutral conductor current intensity or the sum of the power connection current intensities should correspond as far as possible to a current intensity value of zero. The second possibility is in particular advantageous when no neutral conductor is provided. Obviously, this change in the voltages can take place only within certain voltage ranges which correspond to heating powers which are suitable or necessary for the chemical reaction to proceed (the voltages are thus, in particular, not set to zero). If a non-symmetrical load through the electrically heated tube sections occurs (for example, when various tube sections have various electrical resistances), this can at least partially be compensated for by this embodiment.

The apparatus according to the invention for regulatably carrying out a chemical reaction in a process fluid comprises: a reactor having several reaction tubes, which have a number of electrically heatable tube sections, wherein several power connections are provided, which are each connected in a current input area to at least one of the tube sections, wherein at least one connecting element is provided in a current output area, and each of the tube sections is connected to a connecting element so that the latter forms a star point (connecting-element star point); at least one controllable power source (alternating current source) which is configured to provide several variable voltages at the several power connections, wherein the power source provides the several voltages as phases of a multiphase alternating voltage; one or more measuring devices which are configured to detect one or more measured variables; a control apparatus which is connected to the at least one power source and to the one or more measuring devices for communication and which is configured to control the at least one power source as a function of the one or more measured variables. Here, the tube sections connected to various phases of the same power source should be connected to the same connecting element. The change in the voltage can (here, and also in the above-described method) consist of a change in the (voltage) amplitude itself (e.g., by means of variable transformers) and/or in a change in an amplitude averaged over time (in particular, in the root mean square), e.g., by means of phase angle control or wave packet control (in particular, full wave control).

The control apparatus is configured to carry out one of the methods described above or in the further description. In particular, the chemical reaction is one of the following reactions: steam cracking, steam reforming, dry reforming, propane dehydrogenation, a reaction with hydrocarbons which is at least partially carried out at more than 500° C. (i.e., the reactor is configured to carry out one of these chemical reactions).

Preferably, the one or more measuring devices comprise one or more of: one or more temperature sensors, which are further preferably configured to measure temperatures of at least one of the tube sections and/or temperatures of the process fluid at at least one tube inlet and/or at least one tube outlet and/or in at least one tube section, one or more current sensors, which are further preferably configured to measure current intensities at at least one power connection and/or a neutral conductor (which connects the connecting element to a star point of the power source), or one or more substance-composition sensors, which are further preferably configured to measure substance compositions of the process fluid at at least one tube inlet and/or at least one tube outlet.

The voltages can be variable together in the same way (i.e., the power source is configured accordingly), wherein the at least one power source preferably comprises power controllers, and in particular thyristor power controllers, by means of which the voltages can be changed. Alternatively, and more preferably, the voltages can be variable independently of one another, wherein the at least one power source preferably comprises, for each voltage, a variable transformer, by means of which the voltages can be changed independently of one another. Furthermore, alternatively or in addition to power controllers and/or variable transformers, power electronics may also be provided, which implement the same functionality, e.g., a so-called flexible alternating current transmission system (FACTS).

The one or more measuring devices preferably comprise one or both of: one or more temperature sensors arranged at tube outlets of the several reaction tubes, in order to measure one or more temperatures (tube outlet temperatures) of the process fluid, or one or more substance-composition sensors arranged at the tube outlets of the several reaction tubes, in order to measure one or more substance compositions of the process fluid. Alternatively or additionally, one or more temperature sensors and/or one or more substance-composition sensors can likewise be arranged at tube inlets of the several reaction tubes, in order to measure tube inlet temperatures or tube inlet substance compositions.

Preferably, the one or more measuring devices comprise one or both of: two or more tube-section temperature sensors arranged at tube sections connected to various power connections, or two or more power-connection current sensors arranged at various power connections. With these measuring devices, it is possible to measure in particular tube section temperatures and/or power connection current intensities which may be used in a method according to the invention as described above. The control apparatus is accordingly configured to regulate the temperatures of the tube sections and/or the heating powers delivered to the tube sections. If the at least one power source is able to provide the voltages at various power connections independently of one another, the temperatures of different tube sections or the heating powers delivered thereto can be regulated independently of one another, i.e., they can be set to different values/value ranges.

Preferably, the at least one power source is configured to provide the voltages independently of one another, and the one or more measuring devices comprise one or both of: a neutral-conductor current sensor arranged on a neutral conductor connected to the connecting element, or several power-connection current sensors arranged at various power connections. With these sensors, in particular the neutral conductor current intensity and/or the power connection current intensities can be measured. Further preferably (as already mentioned in connection with the method), the control device is configured to control the at least one power source such that voltages with which the neutral conductor current intensity and/or the sum, calculated taking into account the phases, of the power connection current intensities is minimized are provided at the power connections. In principle, this establishes equipotentiality between the elements connected by the neutral conductor, i.e., between the connecting element and a star point of the at least one power source. In particular, it is thereby also possible to the risk that outward currents flow into a production system in which the apparatus according to the invention is set up and which is electrically-conductively connected via the reaction tube at the tube inlet and the tube outlet, and cause electrical disturbances or associated risks.

Within the scope of this application, the terms, “connected,” “connection,” etc., are to be understood in the sense of an electrically-conductive connection, unless stated otherwise.

In addition to the electrical heating according to the invention of the tube sections, the method or the apparatus may also provide non-electrical heating of the reaction tube—for example, by fossil fuels. However, the regulation of the carrying out of the chemical reaction is achieved according to the invention by controlling the voltages applied to the power connections.

The invention is described below first with reference to reaction tubes and reactors as used for steam cracking or for steam reforming. However, the invention may also be used in other reactor types. Generally, as mentioned, the reactor proposed according to the invention can be used for carrying out all endothermic chemical reactions.

The invention is explained in more detail below with reference to the accompanying drawings, which illustrate embodiments of the invention.

In the figures, elements corresponding structurally or functionally to one another are indicated by identical or similar reference signs and, for the sake of clarity, are not explained repeatedly. If components of apparatuses are explained below, the corresponding explanations also in each case relate to the methods carried out therewith, and vice versa. The description of the figures repeatedly refers to alternating current heating.

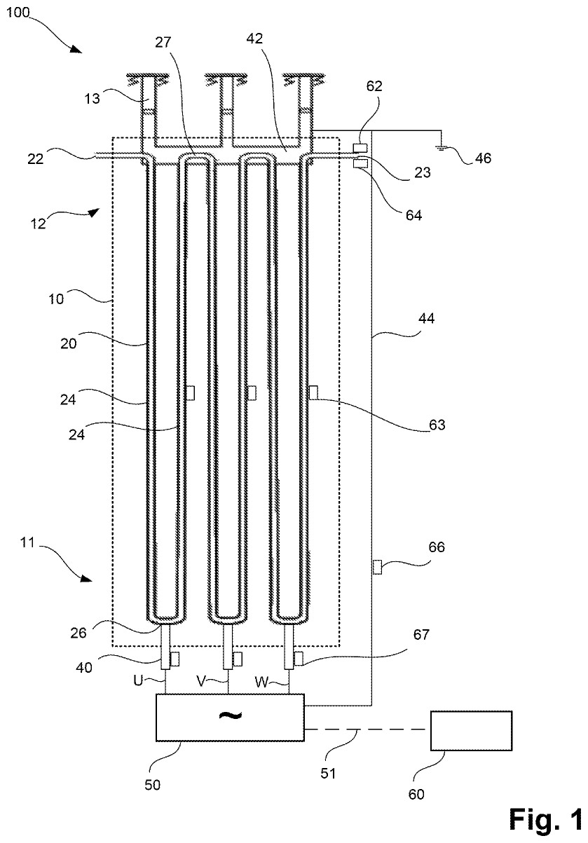

FIG. 1 schematically illustrates an apparatus for carrying out a chemical reaction according to one embodiment according to the invention.

The apparatus comprises a reactor, denoted here by 100, which is configured to carry out a chemical reaction. For this purpose, it in particular has a reaction tube 20 which runs from a tube inlet 22 to a tube outlet 23 through a thermally-insulated reactor vessel 10, wherein a number of tube sections 24 of the reaction tube 20, which are denoted here by 24 only in two instances, run in each case between a current input area 11 and a current output area 12 in the reactor vessel 10. The tube sections 24 form sections of the reaction tube 20, which are respectively fluidically connected to one another in the current input area 11 and in the current output area 12 via curved portions of the reaction tube—more precisely, first U-bends 26 in the current input area 11 and second U-bends 27 in the current output area 12—so that a tube coil is formed through which a process fluid can be conducted from the tube inlet 22 to the tube outlet 23. Here, the reaction tube 20 is fastened by way of example to a support structure (not shown in greater detail) with suitable suspension means 13, wherein differently designed holding structures for the reaction tube are in principle also conceivable. It is understood that, here and below, several reaction tubes may be provided in each case.

The material used for the reaction tube(s) is a material with an electrical conductivity suitable for electrical heating of the reaction tube(s), e.g., heat-resistant steel alloys, and in particular heat-resistant chromium-nickel-steel alloys. Such steel alloys can likewise be used for the power connections (via which the electrical currents are conducted into the reactor vessel) and for the connecting element (which is arranged at least partially in the reactor vessel). For example, materials with the standard designations, GX40CrNiSi25-20, GX40NiCrSiNb35-25, GX45NiCrSiNbTi35-25, GX35CrNiSiNb24-24, GX45NiCrSi35-25, GX43NiCrWSi35-25-4, GX10NiCrNb32-20, GX50CrNiSi30-30, G-NiCr28W, G-NiCrCoW, GX45NiCrSiNb45-35, GX13NiCrNb45-35, GX13NiCrNb37-25, or GX55NiCrWZr33-30-04 according to DIN EN 10027, Part 1, “Materials,” may be used.

For the electrical heating of the tube sections 24 in the power input area 11, the tube sections 24 are in each case electrically-conductively connected or connectable electrically to phase connections U, V, W of a multiphase power source 50, i.e., an alternating current source (one power source is explained below, but also several power sources may be provided; a power source is thus to be understood in the sense of at least one power source, wherein the statements apply to all power sources). Switches and the like, as well as the specific type of connection, are not illustrated. The tube sections 24 are connected in the power input area 11 to power connections 40, wherein each of the power connections 40 is respectively assigned one or more tube sections (two in FIG. 1), to which the respective power connection is connected.

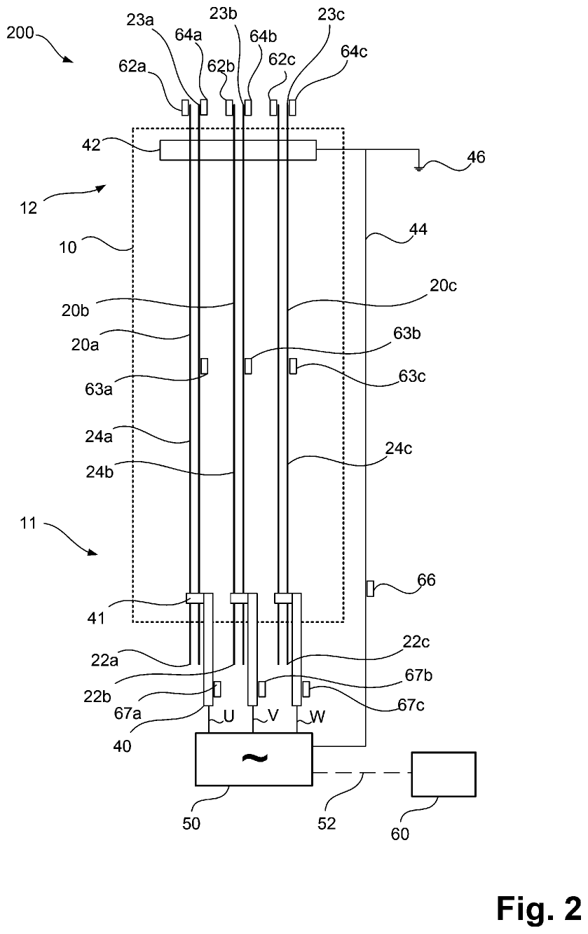

The power source 50 is controllable and configured to provide variable voltages at the power connections 40. For this purpose, the phase connections U, V, W of the power source 50 are connected to power connections 40. In the embodiment according to FIG. 1, the power connections 40 are connected to the first U-bends 26, which in turn are connected to the tube sections 24, since U-bends and tube sections form portions of the reaction tube. In this embodiment, the electrical connection between power connections and tube sections is thus produced indirectly via the U-bends. However, in deviation therefrom, a direct connection of the power connections to the tube sections is likewise possible; see, for example, the embodiment in FIG. 2.

In the embodiment of the invention illustrated here, the tube sections 24 are electrically-conductively connected to one another in the power output area 12 by means of a connecting element 42, which is connected to the one or more reaction tubes 20 and is arranged within the reactor vessel 10. A neutral conductor 44 and/or a grounding 46 can also be connected thereto. The neutral conductor 44 is connected to a corresponding connection of the power source 50—for example, to a star point of the power source. The current fed into the tube sections 24 in the current input area 11 is delivered again from the tube sections 24 in the current output area 12. In terms of circuitry, the connecting element 42 forms a star point in which, with a suitable supply with phase-shifted currents (e.g., with a so-called alternating current) by the voltage supply 50 and with a symmetrical load by the tube sections 24, the currents or voltages cancel one another out, so that no current flows via the neutral conductor 44 to the power source and/or to ground 46 in this case.

Furthermore, a control apparatus 60 is provided, which is connected to the power source 50 for communication, e.g., via a control line 52 (however, any wired or wireless connection may be provided), and which is configured to control the power source 50, wherein in particular the voltages applied by the power source 50 to the power connections 40 can be controlled. For this purpose, the control apparatus 60 is configured to carry out a method according to the invention. The control apparatus 60 (or the method implemented by the control apparatus) carries out this control as a function of measured variables, which are detected by one or more measuring devices.

In particular, temperature sensors, substance-composition sensors, and current sensors can be used as measuring devices. In FIG. 1, a plurality of such measuring devices which may be used are shown by way of example. The measuring devices are connected to the control apparatus 60 via wired or wireless connections for communication or data transmission, so that measured variables detected by the measuring devices can be transmitted to the control apparatus. These connections are not shown in the figure for the sake of clarity. It should also be pointed out that not all shown measuring devices have to be provided and that different or additional measuring devices, not shown, may also be provided. What measuring devices are provided and possibly used depends upon which measured variables are required for the method carried out by the control apparatus.

FIG. 1 shows the following measuring devices: a temperature sensor 62 at the tube outlet 23, which sensor measures the temperature of the process fluid at the tube outlet; a substance-composition sensor 64 at the tube outlet 23, which sensor measures the composition of the process fluid or the proportion of particular substances in the process fluid at the tube outlet; temperature sensors 63 (only one provided with a reference sign), which are arranged on the tube sections 24 in order to measure the temperature of the respective tube section; a current sensor 66 on the neutral conductor 44, in order to measure the current intensity of the current flowing in the neutral conductor (i.e., current between the connecting element 42 and the power source 50); current sensors 67 at the power connections, in order to measure currents flowing through the power connections.

Additionally or alternatively, the following measuring devices (not shown) may also be provided, for example: a temperature sensor at the tube inlet 22, which sensor measures the temperature of the process fluid at the tube inlet; a substance-composition sensor at the tube inlet 22, which sensor measures the composition of the process fluid or the proportion of particular substances in the process fluid at the tube inlet; temperature sensors on portions of the reaction tube 20 between the tube sections 24, e.g., at the first or the second U-bends 26, 27, in order to measure reaction tube temperatures between the tube sections.

FIG. 2 shows an alternative embodiment of an apparatus according to the invention. In this embodiment, the reactor 200 has several reaction tubes 20a, 20b, 20c, each having an electrically heatable tube section 24a, 24b, 24c. The reaction tubes run through a thermally-insulated reactor vessel 10 and each has tube inlets 22a, 22b, 22c and tube outlets 23a, 23b, 23c for process fluids to be processed. For the further configuration, the statements made in connection with FIG. 1 again apply to the extent applicable; in particular, the reaction tubes again run through a thermally-insulated reactor vessel 10, wherein the tube sections are located within the reactor vessel.

The tube sections 24a, 24b, 24c are connected in a current input area 11 to power connections 40, e.g., by means of sleeves 41. The power connections 40 are connected to a power source 50 that is controllable and configured to provide variable voltages at the power connections 40.

Furthermore, the tube sections 24a, 24b, 24c are conductively connected in a current output area 12 to a connecting element 42, so that the tube sections are conductively connected to one another there. The connecting element 42 can be connected again to a ground 46 and/or a neutral conductor 44, wherein the neutral conductor 42 is connected to a corresponding connection of the power source 50.

Likewise, a control apparatus 60 is provided, which is connected to the power source 50 in a wired or wireless manner for communication (e.g., via a control line 52), so that the control apparatus 60 can control the power source 50. Measured variables detected by measuring devices—in particular, temperature sensors, substance-composition sensors, and current sensors—are again used for the control.

By way of example, FIG. 2 again shows several measuring devices, which can be used to detect corresponding measured variables. The measuring devices are connected to the control apparatus 60 via wired or wireless connections for communication or data transmission, so that measured variables detected by the measuring devices can be transmitted to the control apparatus. These connections are not shown in the figure for the sake of clarity. It should also be pointed out that not all shown measuring devices have to be provided and that additional measuring devices, not shown, may also be provided. What measuring devices are provided and possibly used depends upon which measured variables are required for the method carried out by the control apparatus.

FIG. 2 shows the following measuring devices: temperature sensors 62a, 62b, 62b at the tube outlets 23a, 23b, 23c, which sensors measure the temperature of the process fluids at the tube outlets; substance-composition sensors 64a, 64b, 64c at the tube outlets 23a, 23b, 23c, which sensors measure compositions of the process fluids or the proportion of particular substances in the process fluids at the tube outlets; temperature sensors 63a, 63b, 63c, which are arranged on the tube sections 24a, 24b, 24c, in order to measure the temperature of the respective tube section; a current sensor 66 on the neutral conductor 44, in order to measure the current intensity of the current flowing in the neutral conductor (i.e., current between the connecting element 42 and the power source 50); current sensors 67 at the power connections 40, in order to measure currents flowing through the power connections.

Additionally or alternatively, the following measuring devices (not shown) may also be provided, for example: temperature sensors at the tube inlets 22a, 22b, 22c, which sensors measure temperatures of process fluids at the tube inlets; substance-composition sensors at the tube inlets 22a, 22b, 22c, which measure the composition of the process fluids or the proportion of particular substances in the process fluids at the tube inlets.

FIGS. 1 and 2 show specific embodiments of apparatuses according to the invention, in which in particular a specific embodiment of the reaction tubes and the connection thereof to a power source are shown in each case. However, it should be emphasized that, within the scope of the claims (both in the apparatus claims and in the method claims), other embodiments of the reaction tubes and their electrical connection to one power source, or also to several power sources, are possible. In particular, it is possible for the reactor to comprise several tube coils (similarly to FIG. 1), wherein the latter are, for example, arranged in the manner of a stack, parallel to and at a distance from one another (starting from FIG. 1, perpendicularly to the drawing plane).

This set of tube coils (in the stack) can be subdivided into subsets which are each assigned to a power source, wherein also a subdivision in which a subset contains only one tube coil or a subdivision in which a (single) subset contains all the tube coils are possible. The connections are then each assigned to a subset, the tube sections of the tube coils of the subset are connected to one of the connections assigned to the subset, and each subset may be assigned to a power source whose phases are connected to the connections assigned to the subset. For each subset, a connecting element is then likewise provided, which connects the tube sections of the subset, wherein it is also possible for one connecting element to be provided for each individual tube coil.

Likewise, a one-to-one relationship between connections and tube coils can exist (in particular, in the case of a U-shaped tube coil), i.e., all tube sections of a tube coil are respectively connected to the same connection. Since the connections are each connected to various phases or voltages, the number of tube coils then corresponds to the number of various voltages or a multiple thereof. The one or more connecting elements then each connect tube sections of various tube coils.

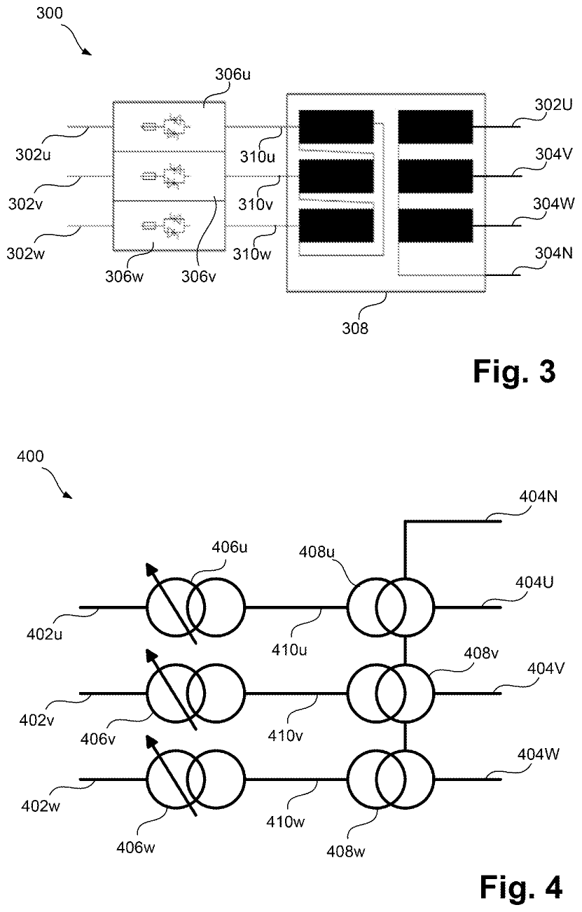

FIG. 3 represents a possible embodiment of a controllable power source 300, which uses thyristor power controllers for power control. The controllable power source has connections on the input side to a power supply, e.g., a power supply network, wherein an input 302u, 302v, 302w is provided for each phase (here, for example, 3) of an AC voltage supply. Relatively high voltages are applied to the inputs—typically, several hundred to several thousand volts, e.g., 400 V, 690 V, or 1.2 kV. On the output side, the power source has outputs 304U, 304V, 304W, which are connected to power connections of a regulatable reactor, e.g., to the power connections 40 of one of the reactors shown in FIG. 1 or 2. Furthermore, a connection 304N for a neutral conductor is provided on the output side.

The power source 300 has power controllers 306u, 306v, 306w—here, thyristor power controllers—by means of which the voltages applied to the inputs can be interrupted or can be passed through to a high-current transformer 308 via lines 310u, 310v, 310w. The multiphase high-current transformer 308—here, for example, in a delta/star configuration, wherein the connection 304N for a neutral conductor is connected to the star point—transforms the relatively high voltages applied between the inputs into lower voltages with simultaneously higher current intensities which are suitable for feeding into the tube sections. The output voltage is preferably in a range of less than 300 V, more preferably less than or equal to 150 V, even more preferably less than or equal to 100 V, and most preferably less than or equal to 50 V.

By correspondingly controlling the power controllers 306u, 306v, 306w, i.e., by alternately interrupting and passing through (by means of the thyristors) the voltages applied to the inputs, to the high-current transformer, the power delivered on the output side can be controlled. For this purpose, a pulse width modulation (PWM) can be used during actuation. Preferably, only full waves of the alternating voltages applied on the input side are passed through by the power controllers, i.e., a so-called pulse group operation or full-wave pulse is provided, in which complete sinusoidal waves are switched through. This serves to reduce harmonics and the associated filter outlay for maintaining the voltage quality on the supply network.

The power controllers are actuated via control lines (not shown), to which are applied control signals based upon voltage requirements specified externally, i.e., by the control apparatus 60.

FIG. 4 shows another possible embodiment of a controllable power source 400, which uses variable transformers for power control and which allows a mutually-independent change in the voltages at the outputs. The controllable power source 400 has connections on the input side to a power supply, e.g., a power supply network, wherein an input 402u, 402v, 402w is provided for each phase (here, for example, 3) of an AC voltage supply. Accordingly, relatively high voltages are applied to the inputs—typically, several hundred to several thousand volts, e.g., 400 V, 690 V, or 1.2 kV. On the output side, the power source has outputs 404U, 404V, 404W, which are connected to power connections of a regulatable reactor, e.g., to the power connections 40 of one of the reactors shown in FIG. 1 or 2. Furthermore, a connection 404N for a neutral conductor is provided on the output side.

The power source 400 comprises variable transformers 406u, 406v, 406w, i.e., transformers whose output-side voltage is controllable in particular regions or even completely, i.e., from 0-100%. The output voltages of the variable transformers, which are relatively high in the case of a correspondingly requested heating power, are transformed by single-phase high-current transformers 408u, 408v, 408w, which are connected to the variable transformers via lines 410u, 410v, 410w, into lower voltages or currents with higher current intensity and are provided by the high-current transformers at the outputs 404U, 404V, 404W. The output voltages are preferably in a range of less than 300 V, more preferably less than or equal to 150 V, even more preferably less than or equal to 100 V, and most preferably less than or equal to 50 V. The connection 404N for a neutral conductor is connected here to a corresponding connection on each of the high-current transformers.

Here, the output powers can be controlled independently of the other output powers for each of the outputs 404U, 404V, 404W, in that the associated variable transformer 406u, 406v, 406w is actuated accordingly, i.e., in that the output voltage at the respective variable transformer is set accordingly. The power controllers are actuated again via control lines (not shown), to which are applied control signals based upon voltage requirements specified externally, i.e., by the control apparatus 60.

The use of a power source with variable transformers has further advantages in addition to the independent controllability of each individual voltage. First, in addition to harmonics, low-frequency voltage oscillations can also be avoided (which, in the embodiment with power controllers can occur due to switching on/off processes). These low-frequency oscillations are disadvantageous, since they can be in the range of resonance frequencies of the reaction tubes on which electromagnetic forces act. Furthermore, when using appropriate variable transformers, the voltages can be controlled from 0-100%, which is useful, for example, during startup/shutdown or during load changes of the reactor; switch-on currents can likewise be limited thereby.

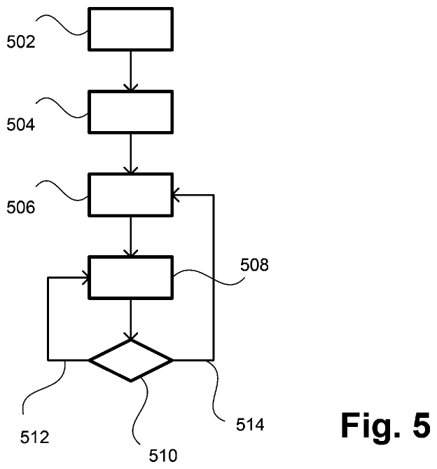

FIG. 5 represents the basic sequence of a method according to the invention, wherein an apparatus according to the invention, as described, for example, in FIG. 1 or FIG. 2, is preferably used, wherein the control apparatus is configured to carry out the method. During the method, a process fluid to be heated or several process fluids to be heated are conducted through one or more reaction tubes of the reactor (step 502).

In step 504, voltages or currents are first provided at power connections of the reactor. This is done by a controllable power source. In step 506, the voltages are set to particular voltage values, e.g., by a control apparatus connected to and controlling the power source.

In step 508, one or more measured values are detected, i.e., measured values (for example, temperature values, current intensity values) of the measured variables (for example, temperature, current intensity) are detected. The measured values are thus the values of the measured variables at a respective measurement time point. For this purpose, as described above (FIGS. 1, 2), measuring devices are provided.

In step 510, the detected measured values are compared with specified values or target values of the corresponding measured variables. It is determined whether the detected measured values correspond to the predetermined values of the measured variables. Here, “correspond” is to be understood in a general sense, i.e., that the detected measured values are equal to or come as close as possible to the predetermined values or are also in particular ranges around the predetermined values.

If the detected measured values correspond to the predetermined values of the measured variables, the measured variables are measured again, i.e., the measured values are detected again; the method thus returns to step 508 (arrow 512). The voltages then remain unchanged. If, on the other hand, the detected measured values do not correspond to the predetermined values of the measured variables, the voltages are set anew, i.e., the method returns to step 506 (arrow 514). The voltages and thus the heating powers in the various associated tube sections are thus changed, such that the values of the measured variables change and subsequently, or after several setting steps, correspond to the predetermined values of the measured variables. For this purpose, for example, a corresponding control algorithm is provided in the control apparatus.

1. A method for regulatably carrying out a chemical reaction in a process fluid in a reactor, comprising:
providing a reactor comprising:
at least one reaction tube, each reaction tube comprising one or more electrically heatable tube section;
several power connections, each power connection being connected in a current input area to a respective tube section; and
at least one connecting element provided in a current output area, wherein each tube section is electrically-conductively connected to theft connecting element;
conducting the process fluid through the at least one reaction tubes;
providing several variable voltages at the several power connections, wherein the several voltages are provided as phases of a multiphase AC voltage so that the at least one connecting element forms a star point;
setting the several voltages;
detecting one or more measured values corresponding to one or more measured variables; and
changing the several set voltages so that the detected measured values correspond to predetermined values or value ranges of the measured variables;
wherein the chemical reaction is selected from the list consisting of: steam cracking, steam reforming, dry reforming, propane dehydrogenation, and a reaction with hydrocarbons, which is carried out at least partially at more than 500° C.

2. The method according to claim 1, wherein the one or more measured variables comprise one or more of:
at least one temperature
at least one current intensity; and/or
at least one substance composition.

3. The method according to claim 1, wherein the several voltages are changed in the same way.

4. The method according to claim 1, wherein the several voltages are changed independently of one another.

5. The method according to claim 1, wherein the one or more measured variables comprise one or both of:
a tube outlet temperature, measured at a tube outlet of the at least one reaction tubes, of the process fluid; and
a substance composition, measured at a tube outlet of the at least one reaction tubes, of the process fluid;
wherein the several voltages are changed such that the measured tube outlet temperature and/or the measured substance composition is substantially equal to a predetermined tube outlet temperature and/or a predetermined substance composition.

6. The method according to claim 1, wherein the one or more measured variables comprise one or both of:
two or more tube section temperatures measured at respective tube sections connected to respective power connections; and
two or more power connection current intensities measured at respective power connections;
wherein the several voltages at the respective power connections are controlled such that:
the measured tube section temperatures correspond to predetermined tube section temperatures; and/or
power outputs, calculated from the current intensities, at the respective tube sections connected to the respective power connections correspond to predetermined power outputs.

7. A method according to claim 1, wherein the one or more measured variables comprise one or both of:
a neutral conductor current intensity measured on a neutral conductor,
two or more power connection current intensities measured at the respective power connections;
wherein the several voltages are changed such that:
the neutral conductor current intensity is minimized; and/or
a sum, calculated taking into account the relative phases, of the power connection current intensities is minimized.

8. An apparatus for the regulated carrying out of a chemical reaction in a process fluid, comprising:
a reactor having at least one reaction tubes, each reaction tube having one or more electrically heatable tube sections;
several power connections, each power connection being connected in a current input area to a respective tube section;
at least one connecting element provided in a current output area each tube sections being connected to the connecting element so that the latter forms a star point;
a controllable power source configured to provide several variable voltages at the several power connections, wherein the power source provides the several voltages as phases of a multiphase AC voltage;
one or more measuring devices configured to detect one or more measured variables;
a control apparatus connected to the power source and to the one or more measuring devices for communication and configured to control the power source as a function of the one or more measured variables;
wherein the control apparatus is configured to carry out a method according to claim 1.

9. The apparatus according to claim 8, wherein the reactor comprises a reactor vessel; and wherein the current input area is arranged within the reactor vessel, and/or the current output area is arranged within the reactor vessel.

10. The apparatus according to claim 8, wherein the one or more measuring devices comprise one or more of:
one or more temperature sensors;
one or more current sensors; and
one or more substance-composition sensors.

11. The apparatus according to claim 8, wherein the power source is configured to change the several voltages together in the same way, wherein the power source preferably comprises power controllers for changing the voltages.

12. The apparatus according to claim 8, wherein the power source is configured to change the several voltages independently of one another, wherein the power source for each voltage comprises a variable transformer or power electronics which implement the functionality of a variable transformer.

13. The apparatus according to claim 8, wherein the one or more measuring devices comprise one or both of:
at least one temperature sensor arranged at a tube outlet of one or more of the at least one reaction tube, in order to measure a temperature of the process fluid; and
at least one substance-composition sensor arranged at a tube outlet of one or more of the at least one reaction tubes, in order to measure a substance composition of the process fluid;
wherein the control apparatus is configured to carry out the method according to claim 5.

14. The apparatus according to claim 8, wherein the one or more measuring devices comprise one or both of:
two or more tube-section temperature sensors arranged on respective tube sections connected to respective power connections; and
two or more power-connection current sensors arranged at respective power connections;
wherein the control apparatus is configured to carry out the method according to claim 6.

15. The apparatus according to claim 8, wherein the reactor comprises several power connections, and wherein the one or more measuring devices comprise one or both of:
a neutral-conductor current sensor arranged on a
neutral conductor connected to the connecting element; and
several power-connection current sensors arranged at respective power connections;
wherein the control apparatus is configured to carry out the method according to claim 7.

16. The apparatus according to claim 11, wherein the power controllers are thyristor power controllers.

17. The method according to claim 2, wherein the several voltages are changed in the same way.

18. The apparatus according to claim 9, wherein the one or more measuring devices comprise one or more of:
one or more temperature sensors;
one or more current sensors; and
one or more substance-composition sensors.

19. The apparatus according claim 10, wherein the power source is configured to change the several voltages together in the same way, wherein the power source preferably comprises power controllers for changing the voltages.

20. The apparatus according to claim 10, wherein the power source is configured to change the several voltages independently of one another, wherein the power source for each voltage comprises a variable transformer or power electronics which implement the functionality of a variable transformer.
